(19) United States
(12) Patent Application Publication
(10) Pub. No.: US 2012/0053976 A1
(43) Pub. Date: Mar. 1, 2012

(54) SYSTEM AND METHOD FOR DETERMINING WHETHER SERVICE COSTS CAN BE REDUCED

(75) Inventors: Bo Hu, Pittsford, NY (US); Sudhendu Rai, Fairport, NY (US)

(73) Assignee: XEROX CORPORATION, Norwalk, CT (US)

(21) Appl. No.: 12/872,912

(22) Filed: Aug. 31, 2010

(51) Int. Cl. G06Q 10/00

(52) U.S. Cl. 705/7.13

(57) ABSTRACT

A method of determining whether labor costs associated with providing a service can be reduced may include identifying a plurality of service locations associated with a service provider, determining a labor cost associated with each service location, where the labor cost includes a cost of compensating the assigned service personnel for performing the service over a period of time, and determining, by the computing device, a total labor cost equal to the sum of the determined labor costs associated with each service location. The method may include determining a pooled labor cost associated with pooling at least a portion of the service personnel from the plurality of service locations, and in response to the total labor cost exceeding the pooled labor cost, transmitting a notification that pooling service personnel results in a reduced labor cost.

### BACKGROUND

In the service industry, capacity decisions are typically handled by individual service locations. For example, a print device supplier may have service personnel associated with multiple service locations who perform services, such as installing, repairing and maintaining print devices for clients. Such service locations are generally autonomous entities that do not operate in conjunction with the other service locations, even if affiliated with the same service provider. As such, each service location is often unaware of the skills and availability of service personnel in other service locations. This leads to inefficiencies and delays in the service providers' performance of services.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimensions recited below. Nothing in this document is to be construed as an admission that the embodiments described in this document are not entitled to antedate such disclosure by virtue of prior invention. As used herein, the term “comprising” means “including, but not limited to.”

In an embodiment, a method of determining whether labor costs associated with providing a service can be reduced may include identifying a plurality of service locations associated with a service provider, where one or more service personnel capable of providing a service are assigned to each service location, determining, by a computing device, a labor cost associated with each service location, where the labor cost includes a cost of compensating the assigned service personnel for performing the service over a period of time, and determining, by the computing device, a total labor cost equal to the sum of the determined labor costs associated with each service location. The method may include determining, by the computing device, a pooled labor cost associated with pooling at least a portion of the service personnel from the plurality of service locations, and in response to the total labor cost exceeding the pooled labor cost, transmitting a notification that pooling service personnel results in a reduced labor cost.

In an embodiment, a method of determining whether labor costs associated with providing a service can be reduced may include determining a number of service personnel associated with a service provider for performing a service such that a response time for performing the service by the number of service personnel is achieved with a specified probability, determining, by a computing device, a full-time marginal cost associated with full-time service personnel of the service provider based on a full-time compensation rate at which full-time service personnel of the service provider are compensated and determining, by the computing device, a part-time marginal cost associated with part-time service personnel of the service provider based on a part-time compensation rate at which part-time service personnel of the service provider are compensated. The method may include comparing the full-time marginal cost and the part-time marginal cost as a function of a number of service personnel, based on the comparison, identifying a service personnel number from the number of service personnel for which the full-time marginal cost equals the part-time marginal cost, determining, by the computing device, a number of full-time service personnel and a number of part-time service personnel, where a sum of the number of full-time service personnel and the number of part-time service personnel equals the number of service personnel, and transmitting a notification comprising one or more of the following: the number of service personnel, the number of full-time service personnel, and the number of part-time service personnel.

In an embodiment, a method of determining whether labor costs associated with providing a service can be reduced may include identifying a plurality of services to evaluate for potential cross-training of service personnel of a service provider, determining a difference value by determining a difference between a rate of labor associated with cross-training the service personnel and a rate of labor associated with not cross-training the service personnel, and determining a cross-training adjustment value based on: the difference value, a turnover rate associated with the service personnel, a number of working days on which at least a portion of the service personnel are available to work, and a number of working hours associated with the determined number of working days. The method may include in response to a threshold value exceeding the cross-training adjustment value, transmitting a notification that cross-training service personnel to perform the identified services reduces labor costs, and in response to a threshold value not exceeding the cross-training adjustment value, transmitting a notification that cross-training service personnel to perform the identified services does not reduce labor costs.

A system of determining whether labor costs associated with providing a service can be reduced may include a computing device and a computer-readable storage medium in communication with the computing device. The computer-readable storage medium may include one or more programming instructions for identifying a plurality of service locations associated with a service provider, where one or more service personnel capable of providing a service are assigned to each service location, determining a labor cost associated with each service location, where the labor cost includes a cost of compensating the assigned service personnel for performing the service over a period of time, and determining a total labor cost equal to the sum of the determined labor costs associated with each service location. The computer-readable storage medium may include one or more programming instructions for determining a pooled labor cost associated with pooling at least a portion of the service personnel from the plurality of service locations, and in response to the total labor cost exceeding the pooled labor cost, transmitting a notification that pooling service personnel results in a reduced labor cost.

### BRIEF DESCRIPTION OF THE DRAWINGS

FIG. 1 illustrates an exemplary service provider that operates two service locations according to an embodiment.

FIG. 2 illustrates an exemplary method of pooling service personnel according to an embodiment.

FIG. 3 illustrates an exemplary method of determining a number of full-time and/or part-time service personnel according to an embodiment.

FIG. 4 illustrates an exemplary full-time marginal cost and an exemplary part-time marginal cost according to an embodiment.

FIG. 5 illustrates an exemplary full-time marginal cost and an exemplary part-time marginal cost according to an embodiment.

FIG. 6 illustrates an exemplary method of determining whether cross-training service personnel reduces labor costs according to an embodiment.

FIG. 7 depicts a block diagram of exemplary internal hardware that may be used to contain or implement program instructions according to an embodiment.

### DETAILED DESCRIPTION

The following terms shall have, for purposes of this application, the respective meanings set forth below:

A “print device” is a device capable of performing one or more print-related functions, operations and/or services. A print device may include a printer, a cutter, a collator, a scanner, a fax machine, a multi-function device or other similar equipment.

A “service provider” is an organization that provides one or more services to other organizations, businesses, individuals and/or the like. A service provider may be an organization that provides repair and/or maintenance service for electronic devices, such as printers, scanners, computers, multi-function devices and/or the like. A service provider may also perform repair and/or maintenance services for automobiles, boats, home appliances, heating, ventilation, air conditioning and/or the like.

A “service request” is a notification from a customer to a service provider of a service-related issue. A service request may be conveyed via a letter, an email, an Internet-based form, a fax, a telephone call and/or the like.

A “service location” is a portion of a service provider that is associated with a subset of all service personnel employed by a service provider.

An “item” is a tangible or intangible asset that can be serviced, repaired, maintained and/or the like. Exemplary items include print devices, electronic devices, computing devices, appliances and/or the like.

For purposes of this application, certain cost reduction measures are described with respect to service locations that service print devices after the devices are sold to users. However, it is understood that additional and/or alternate service types or setups may be used within the scope of this disclosure such as, but not limited to, print shop design, machine operation and domestic services. Similarly, for the purposes of this application, certain cost reduction measures are described with respect to determining labor capacity. However, it is understood that additional and/or alternate capacities may be used within the scope of this disclosure, such as, but not limited to, machine capacity or space capacity.

In an embodiment, a service location may be responsible for dispatching one or more service personnel to a customer's site to respond to a service request, such as a print device failure, malfunction and/or the like. In an embodiment, a service person or service personnel may be an employee, an independent contractor or the like who performs a service on behalf of a service provider. For example, an exemplary service person may be a technician who services a print device.

In an embodiment, a time within which a service person should respond to a service request may be governed by a service level agreement with a customer. For example, a service level agreement between a service provider and a customer may provide that a service person should respond within a certain time period after a service request has been received. In an embodiment, if a service person does not respond within the certain time period, a penalty, such as a financial penalty, may be imposed on the service provider.

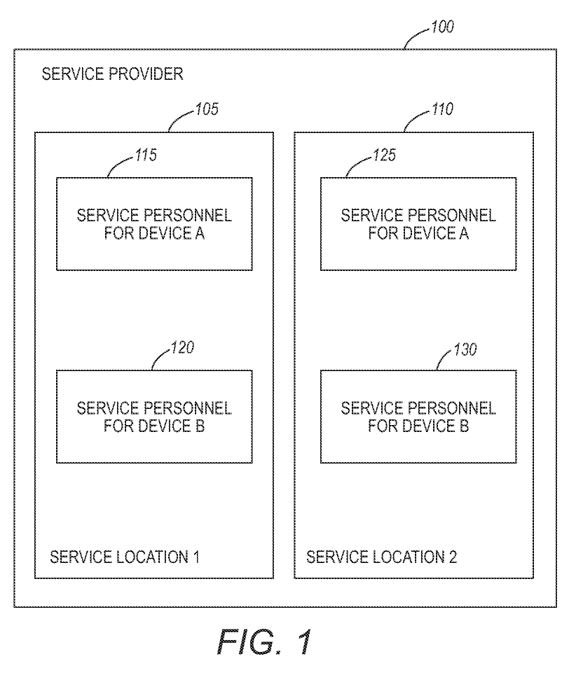

For purposes of this application, FIG. 1 illustrates an exemplary service provider 100 that operates two services locations 105, 110 according to an embodiment. Although, a service provider 100 that operates two service locations 105, 110 is discussed, it is understood that a service provider having an alternate structure or that operates a different number of service locations may be used within the scope of this disclosure. As illustrated by FIG. 1, the two service locations 105, 110 each may have one or more service persons 115, 120, 125, 130 who are responsible for the service of, for example and without limitation, two print devices, Device A and Device B. It is understood that different items and/or a different number of items to be serviced may be used within the scope of this disclosure.

In an embodiment, one or more queuing models may be used to analyze service operations. Service requests arriving at N service locations may form an M/M/N queue. The first “M” stands for the memoryless characteristic of a Poisson process. The second “M” stands for the memoryless characteristic of an exponential distribution. The “N” stands for N number of service personnel who respond to service requests. In an embodiment, the arrival process of an M/M/N queue may follow a Poisson process having a rate of λ. The service time may follow an exponential distribution having a mean of

$$\frac{1}{μ} .$$

In an embodiment, a ratio of an arrival rate to a service rate may be defined as

$$R = \frac{λ}{μ} .$$

T may represent the time between a customer submitting a service request and the customer receiving service. As such:

$$P [ T > 0 ] = 1 - \frac{{\sum }_{m = 0}^{N - 1} ( \frac{{R}^{m}}{m !} )}{{\sum }_{m = 0}^{N - 1} ( \frac{{R}^{m}}{m !} ) + ( \frac{{R}^{N}}{N !} ) ( \frac{1}{1 - \frac{R}{N}} )}$$

In an embodiment, t may represent a threshold value representing an amount of time that T should not exceed. The probability that the waiting for time T is no more than t is represented by:

$$P [ T \leq t ] = 1 - P [ T > 0 ] P [ T > t \vert T > 0 ] = 1 - P [ T > 0 ] exp ( - N μ ( 1 - \frac{R}{N} ) t ) .$$

In an embodiment, customers utilizing both Device A and Device B may have a service level agreement that guarantees one or more service persons will be on site within t hours after a service request is received by a service location. At the first location, Location 1, the arrival of service requests may be represented by a Poisson process having a rate of λ_{1A} for Device A, and a rate of λ_{1B} for Device B. In an embodiment, at the second location, Location 2, the arrival of service requests may be represented by a Poisson process having a rate of λ_{2A} for Device A, and a rate of λ_{2B} for Device B. At both Location 1 and Location 2, the service time, which may include the time needed to travel to a customer's site, may be exponentially distributed with a mean of

$$\frac{1}{{μ}_{A }}$$

for Device A, and a mean of

$$\frac{1}{{μ}_{B}}$$

### for Device B.

In an embodiment, the cost of hiring a full-time service person may be represented by I. In an embodiment, a service level agreement may be achieved with a probability of ρ.

In an embodiment, service requests concerning Device A at Location 1 may form an M/M/N queue. Service requests concerning Device B at Location 1 may form another M/M/N queue. Service requests concerning Device A and Device B at Location 2 may likewise form corresponding M/M/N queues. For service requests concerning Device A at Location 1, a number of service personnel available at Location 1 to service Device A may be determined such that:

P[T≦t|N_{1A}*]>ρ, where N_{1A}* represents the number of service personnel needed at Location 1 to service Device A.

Exemplary parameter values corresponding to an embodiment are identified in Table 1:

TABLE 1

| Parameters | Value |
|---|---|
| λ_{1A} (complaints/hour) | 20 |
| λ_{1B} (complaints/hour) | 17 |
| λ_{2A} (complaints/hour) | 15 |
| λ_{2B} (complaints/hour) | 11 |
| μ_{A} (complaints/hour) | 0.2 |
| μ_{B} (complaints/hour) | 0.1 |
| t (hour) | 2 |
| I ($/hour) | 20 |
| ρ | 0.99 |

In an embodiment, the condition

$${N}_{1 A} > \frac{{λ}_{1 A}}{{μ}_{A}}$$

may be satisfied to minimize the likelihood of a queue being filled beyond its capacity. A number of service personnel who are able to service Device A at Location 1, N_{1A}*, may be determined by a computing device. In an embodiment, N_{1A}* may be determined by:

| $R = \frac{{λ}_{1 A}}{{μ}_{A}}$ | | |
|---|---|---|
| $n = \frac{{λ}_{1 A}}{{μ}_{A}}$ | | |
| While (True) | | |
| | $P [ T > 0 ] = 1 - \frac{{\sum }_{m = 0}^{n - 1} ( {R}^{m} \text{/} m ! )}{{\sum }_{m = 0}^{n - 1} ( {R}^{m} \text{/} m ! ) + ( {R}^{n} \text{/} n ! ) {( 1 \text{/} ( 1 - R \text{/} n ) )}^{′}}$ | |
| | P[T ≦ t] = 1 − P[T > 0] exp(−nμ_{A}(1 − R/n)t), | |
| | If P[T ≦ t] > ρ, | |
| | | N_{1A}^{*} = n |
| | | Break out |
| | Else | |
| | | n = n + 1, |

End If

End While

Using the parameter values set forth above in Table 1, N_{1A}*=109. In other words, to achieve a service level agreement with a probability, ρ, of 99%, 109 service personnel should be available at Location 1.

In an embodiment, a labor cost associated with item to be serviced by a service location may be determined. A labor cost may be determined by multiplying the number of service personnel for each item by a compensation rate associated with the service personnel who service the item. For example, for Device A at Location 1, the number of service personnel is 109. The compensation rate associated with the service personnel is $20/hour. As such, the labor rate associated with Device A at Location 1 is $2,180/hour (i.e., 109*$20). Table 2 below illustrates exemplary numbers of service personnel associated with each device at each location, and corresponding labor costs according to an embodiment.

TABLE 2

| | N_{1A}* | N_{1B}* | N_{2A}* | N_{2B}* |
|---|---|---|---|---|
| # of service personnel | 109 | 185 | 84 | 124 |
| Labor cost (per hour) | 2,180 | 3,700 | 1,680 | 2,480 |

| | |
|---|---|
| Total labor cost (per hour) | 10,040 |

In an embodiment, a total labor cost may be the sum of the labor costs of servicing each item by the number of service personnel associated with each service location. For example, referring to Table 2, the total labor cost is equal to the sum of the labor cost associated with servicing Device A at Location 1 (i.e., $2,180) plus the labor cost associated with servicing Device B at Location 1 (i.e., $3,700) plus the labor cost associated with servicing Device A at Location 2 (i.e., $1,680) plus the labor cost associated with servicing Device B at Location 2 (i.e., $2,480).

In an embodiment, labor costs may be reduced by pooling service personnel across multiple service locations into one shared delivery center (“SDC”). An SDC may be a representation of at least a portion of service personnel across one or more service locations who are capable of providing one or more services. For example, a service provider may have two service locations. One service location, Service Location 1, may service Device A and Device B for Client 1 and Client 2 while another service location, Service Location 2, may service Device A and Device B for Client 3 and Client 4.

In an embodiment, at least a portion of the service personnel from these two service locations may be pooled to form an SDC. In an embodiment, pooling service personnel may mean expanding the services that service personnel can provide by device, customer and/or the like. For example, pooling service personnel across Service Location 1 and Service Location 2 in the example above may mean that each service person affiliated with the service location is permitted to service Device A and/or Device B for Client 1, Client 2, Client 3 and/or Client 4.

In an embodiment, pooling service personnel may not involve physically relocating service personnel. For example, using the example above, pooling service personnel from Service Location 1 and Service Location 2 may not involve physically relocating service personnel to or from Service Location 1, Service Location 2 or another service location. Rather, pooling service personnel may mean that a service personnel may perform a service for a different customer than the service person did prior to pooling. In an embodiment, one or more service requests may be directed to an SDC. The SDC may route a service request to one or more service persons from one or more service locations.

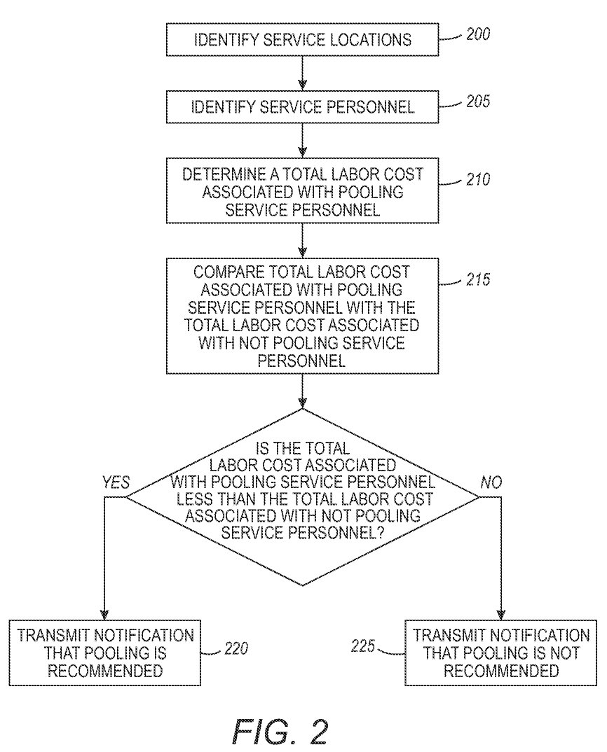

FIG. 2 illustrates an exemplary method of pooling service personnel according to an embodiment. As illustrated by FIG. 2, one or more service locations associated with a service provider may be identified 200. In an embodiment, one or more service locations may be automatically identified 200 by a computing device. For example, information pertaining to one or more service locations may be stored in a database or other computer-readable storage medium in communication with a computing device. The computing device may retrieve information pertaining to one or more of the service locations from storage. In an embodiment, a computing device may automatically retrieve such information from storage. In an alternate embodiment, a computing device may retrieve such information from storage in response to a request or instructions to do so.

In an embodiment, a user may provide information regarding one or more service locations. For example, a user may enter this information into a computing device by way of an input device, such as, but not limited to, a keyboard, a touchpad, a mouse and/or the like. In another embodiment, one or more service locations may be automatically identified 200, and one or more other service locations may be identified by a user.

In an embodiment, the service person or personnel associated with each service location and the services they are capable of providing may be identified 205. In an embodiment, such service personnel and services may be automatically identified 205 by a computing device. For example, information pertaining to a service person or personnel associated with each location and the services they are capable of providing may be stored in a database or a computer-readable storage medium in communication with a computing device. The computing device may retrieve information pertaining to one or more of the service personnel associated with each location and the services they are capable of providing.

In an embodiment, a user may provide information regarding a service person or personnel associated with each location and the services they are capable of providing. For example, a user may enter this information into a computing device by way of an input device, such as, but not limited to, a keyboard, a touchpad, a mouse and/or the like.

In an embodiment, a total labor cost associated with pooling service personnel may be determined 210 for one or more items to be serviced. In an embodiment, service requests associated with an item to be serviced may be represented as the sum of a plurality of Poisson processes, where each Poisson process is associated with a service location whose service personnel are being pooled. For example, referring to FIG. 1, service requests regarding Device A may be represented as the sum of two Poisson processes, one having a mean of λ_{1A} and the other having a mean of λ_{2A}. As such, service requests received by a SDC regarding Device A may be a Poisson process with a mean represented by λ_{A}=λ_{1A}+λ_{2A}.

Service requests regarding Device B may be represented as the sum of two Poisson processes, one having a mean of λ_{1B} and the other having a mean of λ_{2B}. As such, service requests received by a SDC regarding Device B may be a Poisson process with a mean represented by λ_{B}=λ_{1B}+λ_{2B}. In an embodiment, a service rate for Device A may be represented by μ_{A}, and a service rate for Device B may be represented by μ_{B}.

In an embodiment, a number of service personnel to service Device A at Location 1 and/or Location 2, N_{A}*, may be determined by the following:

| $R = \frac{{λ}_{A}}{{μ}_{A}}$ | | |
|---|---|---|
| $n = \frac{{λ}_{A}}{{μ}_{A}}$ | | |
| While (True) | | |
| | $P [ T > 0 ] = 1 - \frac{{\sum }_{m = 0}^{n - 1} ( {R}^{m} \text{/} m ! )}{{\sum }_{m = 0}^{n - 1} ( {R}^{m} \text{/} m ! ) + ( {R}^{n} \text{/} n ! ) {( 1 \text{/} ( 1 - R \text{/} n ) )}^{′}}$ | |
| | P[T ≦ t] = 1 − P[T > 0] exp(−nμ_{A}(1 − R/n)t), | |
| | If | P[T ≦ t] > ρ, |
| | | N_{A}^{*} = n |
| | | Break Out |
| | Else | |
| | | n = n + 1 |

End If

End While

In an embodiment, a number of service personnel who are able to service Device B at Location 1 and/or Location 2, N_{B}*, may be determined by the following:

| $R = \frac{{λ}_{B}}{{μ}_{B}}$ | | |
|---|---|---|
| $n = \frac{{λ}_{B}}{{μ}_{B}}$ | | |
| While (True) | | |
| | $P [ T > 0 ] = 1 - \frac{{\sum }_{m = 0}^{n - 1} ( {R}^{m} \text{/} m ! )}{{\sum }_{m = 0}^{n - 1} ( {R}^{m} \text{/} m ! ) + ( {R}^{n} \text{/} n ! ) {( 1 \text{/} ( 1 - R \text{/} n ) )}^{′}}$ | |
| | P[T ≦ t] = 1 − P[T > 0] exp(−nμ_{B}(1 − R/n)t), | |
| | If | P[T ≦ t] > ρ, |
| | | N_{B}^{*} = n |
| | | Break Out |
| | Else | |
| | | n = n + 1 |

End If

End While

Assuming the parameter values set forth in Table 1, the number of service personnel needed to service Device A and Device B using a pooling model are set forth in Table 3.

TABLE 3

| | N_{A}* | N_{B}* |
|---|---|---|
| # of service personnel | 185 | 297 |

In an embodiment, a labor cost associated with the number of pooled service personnel for servicing each item may be determined. A labor cost may be determined by multiplying the number of service personnel by a compensation cost associated with the service personnel. For example, referring to Table 3, 185 service personnel are needed to service Device A. If the service personnel are compensated at a rate of $20/hour, then the labor cost associated with servicing Device A is $3,700/hour (i.e., 185*$20/hour). Similarly, according to Table 3, 297 service personnel are needed to service Device B. If these service personnel are also compensated at a rate of $20/hour, then the labor cost associated with servicing Device B is $5,940/hour.

In an embodiment, a total labor cost associated with pooling service personnel may be determined. A total labor cost may be the sum of the labor costs associated with each item to be serviced by pooled service personnel. For instance, using the example above, the total labor cost associated with servicing Device A and Device B may be $9,640/hour (i.e., $3,700/hour+$5,940/hour). These labor costs are illustrated in Table 4 below.

TABLE 4

| | N_{A}* | N_{B}* |
|---|---|---|
| # of service personnel | 185 | 297 |
| Labor cost | 3,700 | 5,940 |

| | |
|---|---|
| Total labor cost | 9,640 |

In an embodiment, the total labor cost associated with pooling service personnel may be compared 215 to the total labor cost when personnel are not pooled. If the total labor cost associated with pooling service personnel is less than the total labor cost when personnel are not pooled, a notification may be provided 220 to a user. In an embodiment, the notification may inform a user that pooling service personnel is recommended because doing so would reduce labor costs. For example, an email may be sent to a user notifying the user that pooling service personnel may reduce labor costs. In an embodiment, a notification may be displayed on a user interface of a computing device that notifies a user that pooling service personnel may reduce labor costs.

In an embodiment, if the total labor cost associated with pooling service personnel is less than the total labor cost when personnel are not pooled, at least a portion of the service personnel may be pooled. In an embodiment, a service may be performed by one or more of the pooled service personnel.

In an embodiment, if the total labor cost associated with pooling service personnel exceeds or is equal to the total labor cost when personnel are not pooled, a notification may be transmitted 225 to a user. In an embodiment, the notification may inform a user that pooling service personnel is not recommended because it would not reduce labor costs. For example, an email may be sent to a user notifying the user that pooling service personnel may not reduce labor costs. In an embodiment, a notification may be displayed on a user interface of a computing device that notifies a user that pooling service personnel may not reduce labor costs.

For example, as illustrated by Table 4, by pooling service capacity in a SDC, the number of service personnel needed to achieve service requirements decreased by approximately 4%. In an embodiment, a notification may include a labor cost associated with not pooling service personnel, a labor cost associated with pooling service personnel, an amount of cost savings and/or the like. This information may be presented through the use of text, pictures, charts or other visual depictions.

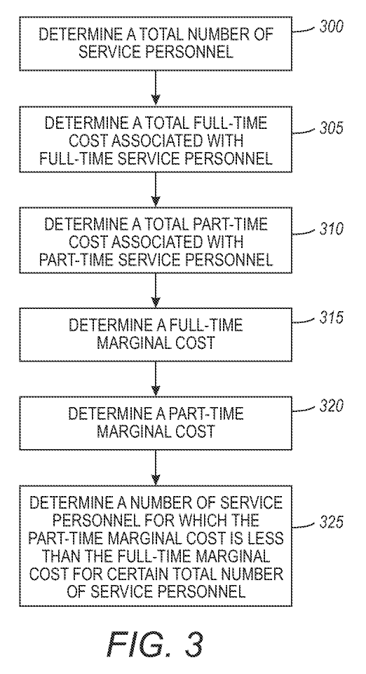

In an embodiment, labor costs associated with a service provider may be reduced by utilizing both full-time and part-time service personnel. FIG. 3 illustrates an exemplary method of determining a number of full-time and/or part-time service personnel according to an embodiment. As illustrated by FIG. 3, a total number of service personnel to perform one or more services may be determined 300. For example, a total number of service personnel to service Device A may be determined 300. For example, as discussed above, a total number of service personnel to service Device A may be 185.

In an embodiment, as discussed above, a number of full-time service personnel needed to perform a service may be determined such that P[T≦t|N_{1A}*]>ρ, where N* represents the number of full-time service personnel needed to perform a service. For example, as discussed above, a number of full-time service personnel needed at Location 1 to service Device A may be determined such that P[T≦t|N_{1A}*]>ρ, where N_{1A}* represents the number of full-time service personnel needed at Location 1 to service Device A.

In an embodiment, a total full-time cost associated with full-time service personnel for a service provider may be determined 305. A full-time cost may be a rate at which a full-time service personnel is compensated. For example, a full-time cost may be an hourly rate at which a full-time service personnel is compensated. A total full-time cost may represent a rate at which all full-time service personnel are compensated. For example, if all full-time service personnel are paid the same hourly rate, the total full-time cost may be that hourly rate. In an embodiment, if full-time service personnel are not paid the same hourly rate, the total full-time cost may be an average hourly rate for the full-time service personnel.

In an embodiment, a total full-time cost associated with full-time service personnel may be determined by a computing device after receiving a total full-time cost from a database or other storage medium. In an embodiment, a total full-time cost may be received by a computing device from a user via an input device such as a keyboard, a mouse, a touch screen and/or the like.

In an embodiment, a total part-time cost associated with part-time service personnel for a service provider may be determined 310. A part-time cost may be a rate at which part-time service personnel are compensated. A total part-time cost may represent a rate at which all part-time service personnel are compensated. For example, the total part-time cost may be an average hourly rate for the part-time service personnel.

In an embodiment, a total part-time cost associated with part-time service personnel may be determined 310 by a computing device after receiving a total part-time cost from a database or other storage medium. In an embodiment, a total part-time cost may be received by a computing device from a user via an input device such as a keyboard, a mouse, a touch screen and/or the like.

In an embodiment, a total part-time cost associated with part-time service personnel may be higher than a total full-time cost associated with full-time service personnel. For example, the total part-time cost for part-time service personnel who service Device A may be $35/hour while the total full-time cost for full-time service personnel who service Device A may be $20/hour.

In an embodiment, a full-time marginal cost associated with full-time service personnel may be determined 315. A full-time marginal cost may be a change in the total full-time cost that arises when the number of full-time service personnel increases by one person. In an embodiment, a part-time marginal cost associated with part-time service personnel may be determined 320. A part-time marginal cost may be a change in the total part-time cost that arises when the number of part-time service personnel increases by one person.

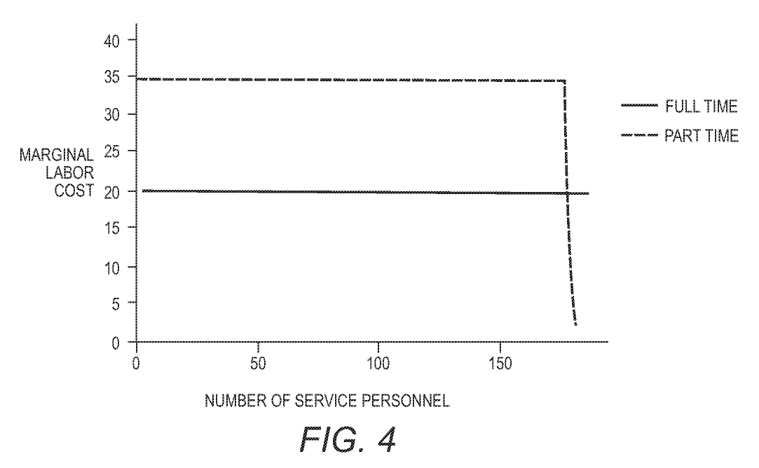

FIG. 4 illustrates an exemplary full-time marginal cost for full-time service personnel who service Device A, and an exemplary part-time marginal cost for part-time service personnel who service Device A. In an embodiment, full-time service personnel may be paid for all business hours, regardless of whether the personnel actually worked the hours. As such, the full-time marginal cost may be equal to I_{f}. For example, the full-time marginal cost illustrated in FIG. 4 is $20/hour.

In an embodiment, a part-time marginal cost associated with part-time service personnel may be equal to Iₚ multiplied by the probability that the part-time service personnel are actually working. In an embodiment, the part-time marginal cost of the N-th service personnel may be represented by: Iₚ*P[T>t|N−1].

In an embodiment, as the number of service personnel increases, the probability that the last hired part-time service personnel is needed and the part-time marginal cost decreases. In an embodiment, a number of service personnel may be determined 325 for which the associated part-time marginal cost is less than the full-time marginal cost associated with the same number of service personnel. In an embodiment, the determined number of service personnel may be identified as the number of required full-time personnel. In an embodiment, the number of part-time service personnel may be determined. The number of part-time service personnel may equal the difference between the total number of service personnel and the determined number of full-time service personnel.

For example, referring to FIG. 4, the part-time marginal cost of the 177^{th} part time service person is lower than the value of I_{f}. As such, 176 full-time service personnel may be needed to service Device A. As described above, a total of 185 service personnel are needed to service Device A. The number of part-time service personnel needed is therefore 9 (i.e., 185−176). As such, to maintain ρ, 185 service personnel are needed, 176 of which are full-time service personnel and 9 of which are part-time service personnel. For example, as illustrated by FIG. 4, the part-time marginal cost of the 177^{th} part-time service personnel is lower than the value of I_{f}. To maintain ρ, 185 service personnel are needed, 176 of which are full-time service personnel and 9 of which are part-time service personnel.

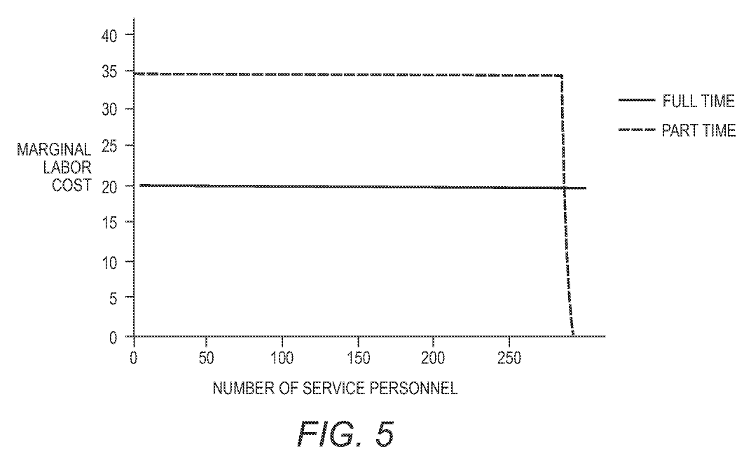

FIG. 5 illustrates a marginal hourly labor cost for full-time service personnel and a marginal hourly labor cost for part-time service personnel who service Device B. As discussed above, the marginal hourly cost of hiring the N-th part-time service person may be represented by: Iₚ*P[T>t|N−1]. In an embodiment, as the number of service personnel increases, the probability that the last hired part-time service person is needed decreases, as does the marginal hourly cost. For example, as illustrated by FIG. 5, to maintain ρ, 297 service personnel may be hired, but 15 of them can be part-time service personnel. Table 5 illustrates exemplary staffing and costs associated with FIG. 1 and FIG. 2 according to an embodiment.

TABLE 5

| | N_{A}* | N_{B}* |
|---|---|---|
| # of full-time employees | 176 | 282 |
| # of part-time employees | 9 | 15 |
| Total # of employees | 185 | 297 |
| Full-time employee cost | 3,520 | 5,640 |
| Expected part-time technician | 33 | 61 |
| cost | | |
| Labor cost | 3,353 | 5,701 |

| | |
|---|---|
| Total labor cost | 9,254 |

As illustrated by Table 5, the total labor cost after analyzing part-time employee usage (i.e., 9,254) is less than the total labor cost from pooling service personnel (i.e., 9,640) and the total labor cost before pooling and analyzing part-time employee usage (i.e., 10,040).

In an embodiment, a notification may be transmitted to a user. The notification may be transmitted to a user via email. In an embodiment, a notification may be displayed on a user interface of a computing device. A notification may include one or more of the number of service personnel, the number of full-time service personnel and/or the number of part-time service personnel.

In an embodiment, a user may use a received notification to adjust the composition of one or more service locations. For example, a user may assign the number of full-time service personnel and/or the number of part-time service personnel to one or more service locations. In an embodiment, the composition of one or more service locations may be automatically adjusted based on a notification.

In an embodiment, labor costs may be reduced by cross-training personnel. Cross-trained personnel may be those who have received training in different skills or tasks. For example, a cross-trained service technician may be trained to service both Device A and Device B.

In an embodiment, cross-training service personnel may offset demand variances and lower labor costs. Arrival of complaints may follow a stochastic process, so extra personnel may be needed to safeguard against variation in arrival of complaints. However, by cross-training service personnel, a service provider may require fewer service personnel to cover the variance that might occur.

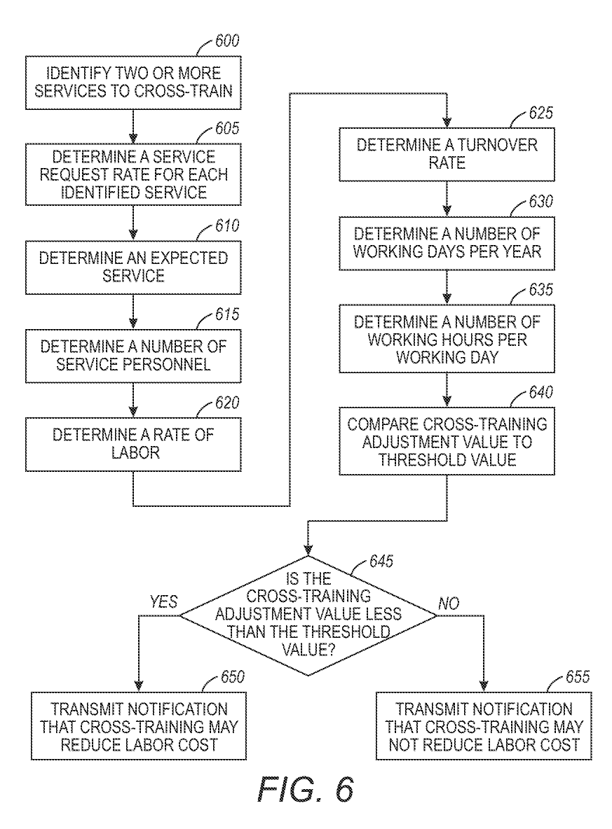

FIG. 6 illustrates an exemplary method of determining whether cross-training service personnel will reduce labor costs according to an embodiment. In an embodiment, a service person who is cross-trained may be trained to perform two or more different services. These services may include performing two or more services on a single item, performing one or more services on two different items and/or the like. For instance, referring to the example above, a service person may be cross-trained to service both Device A and Device B.

As illustrated by FIG. 6, two or more services in which a service person is to be cross-trained may be identified 600. In an embodiment, services may be identified automatically by a computing device. Alternatively, services may be identified by a user. A user may select two or more services for which to evaluate cross-training. A user may select services on a computing device via an input device such as a touch screen, a keyboard, a mouse and/or the like.

In an embodiment, a service request rate may be determined 605 for each of the identified services. A service request rate may be a rate at which service requests are received for a service. For example, a service request rate for Device A and Device B may be 63 requests per hour. Of the 63 requests, 35 requests may be for Device A, and 28 requests may be for Device B. In an embodiment, a service request rate for a service may be determined by examining historical data associated with the service. For example, a service request rate may be an actual number of received service requests for the service over a period of time. In an embodiment, a service request rate may be an average number of received service requests for a service over a period of time. In an embodiment, a service request rate may be received from a device that is being serviced, a computing device in communication with a computer-readable storage medium on which historical service request data is stored and/or the like.

In an embodiment, an expected service time of a dispatch for the identified services may be may be determined 610. In an embodiment, an expected service time of a dispatch for the identified services may be determined 610 by:

$$( \frac{{SR}_{1}}{{SR}_{T}} ) * {A}_{1} + ( \frac{{SR}_{2}}{{SR}_{T}} ) * {A}_{2} + … + ( \frac{{SR}_{N}}{{SR}_{T }} ) * {A}_{N} = EST$$

where,
SR₁=service request rate for Service 1
SR₂=service request rate for Service 2
SR_{N}=service request rate for Service N
SR_{T}=total service request rate=SR₁+SR₂+ . . . +SR_{N}
A₁=average service time associated with performing Service 1
A₂=average service time associated with performing Service 2
A_{N}=average service time associated with performing Service N
EST=expected service time

For instance, referring to the example above, an expected service time of a dispatch for servicing Device A and Device B may be determined 610 by:

$$( \frac{35}{63} ) * 5 + ( \frac{28}{63} ) * 10 = 7.222 hours$$

In an embodiment, an expected service rate may be represented by

$$\frac{1}{EST} .$$

For example, the expected service rate with respect to the above example may be

$$\frac{1}{7.222} = 0.138$$

service requests/hour.

In an embodiment, the expected service time and/or the expected service rate may be used with the queuing model described above to determine 615 a number of service personnel needed to achieve a SLA with a certain probability. For example, using the example above, it may be determined 615 that 471 service personnel are necessary to achieve a SLA with a probability of 0.99.

In an embodiment, it may be determined whether labor costs may be reduced by cross-training service personnel in service locations whose service personnel have been pooled. In an embodiment, it may be assumed that a total labor cost associated with pooling service personnel remains at the same level when service personnel are cross-trained. For example, referring to the above example, the total labor cost associated with pooling service personnel is $9,640. In an embodiment, an hourly rate of labor may be determined 620 for the number of service personnel. An hourly rate of labor may be determined by dividing the total labor cost by the number of service personnel. For instance, regarding the above example, an hourly rate of labor may be determined by

$$\frac{\$9 \text{,} 640}{471} = \$20 .5 / hour .$$

In an embodiment, the determined hourly rate of labor associated with cross-training service personnel may be compared to the hourly rate of labor associated with not cross-training service personnel. For example, the $20.5/hour rate of labor may be compared to the $20/hour rate of labor associated with service personnel that are pooled but not cross-trained. In an embodiment, a difference between the hourly rate of labor associated with cross-training service personnel and the hourly rate of labor associated with not cross-training service personnel may be determined.

In an embodiment, a turnover rate associated with service personnel may be determined 625. In an embodiment, a turnover rate may be represented by z. A turnover rate may be a rate at which service personnel leave a service provider, whether voluntary or involuntary, over a period of time. For example, a turnover rate may be a rate at which service personnel are fired from or quit a service provider. In an embodiment, a turnover rate may be an average rate at which service personnel leave a service provider over a period of time.

In an embodiment, a number of working days per year may be determined 630. A working day may be any day on which service personnel are available to work. For example, if service personnel are available to work on any day, a number of working days would equal 365. In an embodiment, a number of working days may be an average number of days per year that service personnel are available to work.

In an embodiment, a number of working hours per day may be determined 635. Working hours may be the number of hours per day that service personnel are available to work. For example, service personnel may be available to perform a service between 9 am and 5 pm every day, in which case the number of working hours would be 8 hours per day. In an embodiment, a number of working hours may be an average number of hours per day that service personnel are available to work.

In an embodiment, a cross-training adjustment value may be determined 640. A cross training adjustment value may be determined 640 by:

$$\frac{( y * z )}{( a * b )} ,$$

where:
y=a difference between a training cost to cross-train a service person and the training cost of training a service person who is not cross-trained ($);
z=turnover rate (%/year);
a=a number of working days per year (days/year);
b=a number of working hours per day (hours/day).

In an embodiment, the cross-training adjustment value may be compared 645 to a threshold value. In an embodiment, a threshold value may be a different between an hourly rate of labor associated with cross-training a service person and an hourly rate of labor associated with not cross-training a service person. If the cross-training adjustment value is less than the threshold value, a notification may be transmitted 650 to a user that cross-training service personnel may reduce labor costs. In an embodiment, if the cross-training adjustment value equals or is greater than the threshold value, a notification may be transmitted 655 to a user that cross-training is not recommended for the associated service provider.

For instance, referring to the above example, assuming the following values: y=$0.50, z=35%/year, a=260 days/year and b=8 hours/day, a cross-training adjustment value may be determined by:

(0.50*35)/(260/8)=17.50/32.50=$0.53/hour

In an embodiment, a threshold value may be the difference between the rate of labor associated with service personnel that are cross-trained, $20.5/hour, and the rate of labor associated with service personnel that are not cross-trained, $20/hour. In other words, the threshold value may be $0.50/hour.

In an embodiment, if the cross-training adjustment value equals or exceeds the threshold value, a notification may be transmitted to a user that cross-training is not recommended. For instance, in the example above, the cross-training adjustment value (i.e., $0.53/hour) exceeds the threshold value (i.e., $0.50/hour), so a notification may be transmitted to a user that cross-training is not recommended. In an embodiment, if the cross-training adjustment value is less than the threshold value, a notification may be transmitted to a user that cross-training is recommended. In an embodiment, service personnel of a service provider may cross-train or not cross-train at least a portion of the service personnel based on the notification.

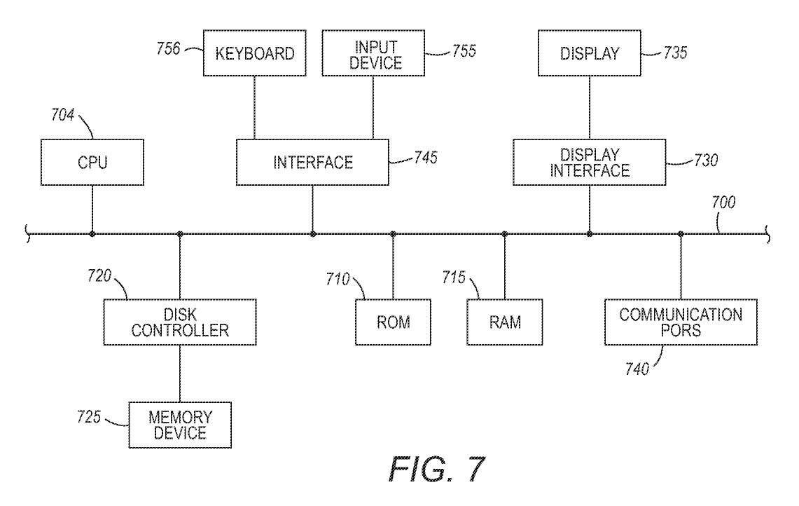

FIG. 7 depicts a block diagram of exemplary internal hardware that may be used to contain or implement program instructions according to an embodiment. A bus 700 serves as the main information highway interconnecting the other illustrated components of the hardware. CPU 705 is the central processing unit of the system, performing calculations and logic operations required to execute a program. Read only memory (ROM) 710 and random access memory (RAM) 715 constitute exemplary memory devices.

A controller 720 interfaces with one or more optional memory devices 725 to the system bus 700. These memory devices 725 may include, for example, an external or internal DVD drive, a CD ROM drive, a hard drive, flash memory, a USB drive or the like. As indicated previously, these various drives and controllers are optional devices.

Program instructions may be stored in the ROM 710 and/or the RAM 715. Optionally, program instructions may be stored on a tangible computer readable storage medium such as a hard disk, compact disk, a digital disk, flash memory, a memory card, a USB drive, an optical disc storage medium, such as Blu-ray™ disc, and/or other recording medium.

An optional display interface 730 may permit information from the bus 700 to be displayed on the display 735 in audio, visual, graphic or alphanumeric format. Communication with external devices may occur using various communication ports 740. An exemplary communication port 740 may be attached to a communications network, such as the Internet or an intranet.

The hardware may also include an interface 745 which allows for receipt of data from input devices such as a keyboard 750 or other input device 755 such as a mouse, a joystick, a touch screen, a remote control, a pointing device, a video input device and/or an audio input device.

An embedded system, such as a sub-system within a xerographic apparatus, may optionally be used to perform one, some or all of the operations described herein. Likewise, a multiprocessor system may optionally be used to perform one, some or all of the operations described herein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of determining whether labor costs associated with providing a service can be reduced, the method comprising:
identifying a plurality of service locations associated with a service provider, wherein one or more service personnel capable of providing a service are assigned to each service location;
determining, by a computing device, a labor cost associated with each service location, wherein the labor cost comprises a cost of compensating the assigned service personnel for performing the service over a period of time;
determining, by the computing device, a total labor cost equal to the sum of the determined labor costs associated with each service location;
determining, by the computing device, a pooled labor cost associated with pooling at least a portion of the service personnel from the plurality of service locations; and
in response to the total labor cost exceeding the pooled labor cost, transmitting a notification that pooling service personnel results in a reduced labor cost.

2. The method of claim 1, wherein determining a labor cost associated with each service location comprises, for each service location:
identifying a Poisson process representing a queue of service requests for the service at the service location, wherein the Poisson process is associated with a mean value and a service rate value;
determining, based on the mean value and the service rate value, a number of service personnel to provide the service at the service location such that a service level agreement is achieved with at least a threshold probability; and
multiplying the number of service personnel by a compensation rate associated with the service personnel at the service location.

3. The method of claim 1, further comprising:
in response to the total labor cost exceeding the pooled labor cost, pooling the portion of the service personnel from the plurality of service locations; and
performing, by the pooled portion of service personnel, the service.

4. A method of determining whether labor costs associated with providing a service can be reduced, the method comprising:
determining a number of service personnel associated with a service provider for performing a service such that a response time for performing the service by the number of service personnel is achieved with a specified probability;
determining, by a computing device, a full-time marginal cost associated with full-time service personnel of the service provider based on a full-time compensation rate at which full-time service personnel of the service provider are compensated;
determining, by the computing device, a part-time marginal cost associated with part-time service personnel of the service provider based on a part-time compensation rate at which part-time service personnel of the service provider are compensated;
comparing the full-time marginal cost and the part-time marginal cost as a function of a number of service personnel;
based on the comparison, identifying a service personnel number from the number of service personnel for which the full-time marginal cost equals the part-time marginal cost;
determining, by the computing device, a number of full-time service personnel and a number of part-time service personnel, wherein a sum of the number of full-time service personnel and the number of part-time service personnel equals the number of service personnel; and
transmitting a notification comprising one or more of the following:
the number of service personnel,
the number of full-time service personnel, and
the number of part-time service personnel.

5. The method of claim 4, wherein determining a number of service personnel comprises pooling at least a portion of service personnel from a plurality of service locations.

6. The method of claim 4, wherein the full-time marginal cost represents a change in a total full-time cost that occurs when a number of full-time service personnel increases by one.

7. The method of claim 4, wherein the part-time marginal cost represents a change in a total part-time cost that occurs when a number of part-time service personnel increases by one.

8. The method of claim 4, wherein determining a part-time marginal cost comprises:
multiplying the part-time compensation rate by a probability that the part-time service personnel of the service provider are working.

9. The method of claim 4, further comprising:
determining a total labor cost by multiplying the number of service personnel by the full-time compensation rate;
determining a full-time cost by multiplying the number of full-time service personnel by the full-time compensation rate;
determining a part-time cost by multiplying the number of part-time service personnel by the part-time compensation rate;
in response to a sum of the full-time cost and the part-time cost being less than the total labor cost, transmitting a notification that having the number of full-time service personnel and the number of part-time service personnel reduces the total labor cost.

10. The method of claim 4, further comprising:
adjusting a composition of service personnel in one or more service locations associated with the service provider based on the notification.

11. A method of determining whether labor costs associated with providing a service can be reduced, the method comprising:
identifying a plurality of services to evaluate for potential cross-training of service personnel of a service provider;
determining a difference value by determining a difference between a rate of labor associated with cross-training the service personnel and a rate of labor associated with not cross-training the service personnel;
determining a cross-training adjustment value based on:
the difference value;
a turnover rate associated with the service personnel;
a number of working days on which at least a portion of the service personnel are available to work; and
a number of working hours associated with the determined number of working days;
in response to a threshold value exceeding the cross-training adjustment value, transmitting a notification that cross-training service personnel to perform the identified services reduces labor costs; and
in response to a threshold value not exceeding the cross-training adjustment value, transmitting a notification that cross-training service personnel to perform the identified services does not reduce labor costs.

12. The method of claim 11, further comprising:
for each identified service, determining an expected service time by:
determining a ratio of a service request rate for the identified service to a total service request rate, and
multiplying the ratio by an average service time associated with the identified service;
determining a total expected service time by summing the expected service times associated with each identified service; and
determining a number of service personnel based on the total expected service time.

13. The method of claim 12, wherein determining a number of service personnel comprises determining a number of service personnel to achieve a service level agreement with at least a threshold probability.

14. The method of claim 12, further comprising:
determining the rate of labor associated with cross-training the service personnel by dividing a total labor cost by the number of service personnel.

15. The method of claim 11, wherein determining a cross-training adjustment value comprises:
determine a first value by multiplying the difference value by the turnover rate;
determining a second value by multiplying the number of working days by the number of working hours; and
dividing the first value by the second value.

16. The method of claim 11, further comprising:
in response to a threshold value not exceeding the cross-training adjustment value, cross-training the service personnel to perform the identified services.

17. A system of determining whether labor costs associated with providing a service can be reduced, the system comprising:
a computing device; and
a computer-readable storage medium in communication with the computing device, wherein the computer-readable storage medium comprises one or more programming instructions for:
identifying a plurality of service locations associated with a service provider, wherein one or more service personnel capable of providing a service are assigned to each service location,
determining a labor cost associated with each service location, wherein the labor cost comprises a cost of compensating the assigned service personnel for performing the service over a period of time,
determining a total labor cost equal to the sum of the determined labor costs associated with each service location,
determining a pooled labor cost associated with pooling at least a portion of the service personnel from the plurality of service locations, and
in response to the total labor cost exceeding the pooled labor cost, transmitting a notification that pooling service personnel results in a reduced labor cost.

18. The system of claim 17, wherein the one or more programming instructions for determining a labor cost associated with each service location comprises one or more programming instructions for:
for each service location:
identifying a Poisson process representing a queue of service requests for the service at the service location, wherein the Poisson process is associated with a mean value and a service rate value,
determining, based on the mean value and the service rate value, a number of service personnel to provide the service at the service location such that a service level agreement is achieved with at least a threshold probability, and
multiplying the number of service personnel by a compensation rate associated with the service personnel at the service location.
